(19) United States
(12) Patent Application Publication
(10) Pub. No.: US 2004/0083323 A1
(43) Pub. Date: Apr. 29, 2004

(54) Large array of SATA data device assembly for use in a peripheral storage system

(76) Inventors: Josef Rabinovitz, Chatsworth, CA (US); Eli Danino, Chatsworth, CA (US)

Correspondence Address: W. Edward Johansen, 11661 San Vicente Boulevard, Los Angeles, CA, 90049, US

(21) Appl. No.: 10/281,899

(22) Filed: Oct. 24, 2002

(51) Int. Cl. G06F 13/36

(52) U.S. Cl. 710/315

(57) ABSTRACT

A combined computer system and peripheral data storage subsystem include a computer system has a host PCI bus and a parallel PCI to serial PCI bridge coupled to the host PCI bus and a peripheral data storage subsystem having an enclosure having a back-plane with slots for fifteen serial ATA storage devices, fifteen serial ATA data storage devices each of which is inserted into one of the fifteen slots of the back-plane, a first serial ATA to parallel PCI bridge disposed in the enclosure and coupled to each of eight of the fifteen serial ATA storage devices, a second serial ATA to parallel PCI bridge disposed in the enclosure and coupled to each of the remaining seven of the fifteen serial ATA storage devices and a parallel PCI to serial PCI bridge coupled to the first and second serial ATA to PCI parallel bridges, and a serial PCI link interconnect wherein the serial PCI link interconnect couples the parallel PCI to serial PCI bridge of the peripheral data storage subsystem to the serial PCI host bus adapter of the computer system.

### BACKGROUND OF THE INVENTION

U.S. Pat. No. 5,822,184 teaches a modular data device assembly for a computer that has a housing. Individual plug-in data storage devices such as hard disk drives or CD-ROM drives are disposed vertically in a stacked formation within the housing. A motherboard with plug-in connectors to which the drives are connected allows easy replacement of defective data devices, which devices slide in or out. The disk drives and modular data device assemblies may be arrayed in series or in parallel to a controller. Its modular structure and redundant storage functions allows it to benefit from what is known as Redundant Array of Inexpensive Disk principle (RAID).

U.S. Pat. No. 5,224,019 teaches a modular computer chassis that includes a main chassis to which a motherboard is attached and a sub-chassis attachable to the main chassis. The sub-chassis holds at least one computer component and is electrically connected to the motherboard. In this manner, the computer component is separable from the main chassis by removing the sub-chassis.

U.S. Pat. No. 5,224,020 teaches a modular electrical apparatus that includes a plurality of customer removable electrical devices such as disk drives. The devices and support units are all blind pluggable into a removable central electrical distribution unit.

U.S. Pat. No. 5,006,959 and U.S. Pat. No. 5,119,497 teach a computer apparatus with modular components that includes segregated functional units like a disk array, various plug-in card packages, power/fan unit, and a motherboard.

A goal for moving towards modular computer components is to improve reliability. One concept in the field of disk drives is known as Redundant Array of Inexpensive Disk (RAID). A number of disk drives are interconnected in an array for redundant storage of data. Failure of one disk drive does not destroy irreplaceable data. An example of the RAID concept is disclosed in U.S. Pat. No. 4,754,397 teaches a housing array for containing a plurality of hardware element modules such as disk drives, a plurality of modularized power supplies, and plural power distribution modules, each being connected to a separate source of primary facility power. Each module is self-aligning and is blind-installable within the housing. Each module may be installed and removed without tools, without disturbing the electrical cabling within the cabinet, and automatically by a maintenance robot. Despite the advances in designing modular components and associated hardware for computers, there is still a need for a modular component that easily adapts to conventional size restraints, yet benefits from RAID concepts.

U.S. Pat. No. 6,188,571 teaches an apparatus for a mass storage subsystem, such as a RAID array, that includes a housing which defines first and second cavities with the first cavity housing an array controller such as a RAID controller. The second cavity houses a plurality of IDE drives conforming to the 3.5″ form factor. The array is configured to maximize cooling of the array controller and the drives within the extremely small space defined by the housing.

U.S. Pat. No. 6,363,211 teaches video data and audio data that are inputted respectively from a camera system and a microphone and are compressed and encoded in a video compressor/expander-encoder/decoder and an audio compressor/expander-encoder/decoder respectively, and then are multiplexed in a multiplexer. Subsequently the multiplexed data are supplied to a hard disk drive via an AV interface, a host bus, an interface adaptor and an interface. Information representing the kind of the data is written in a register. The data supplied to the hard disk drive are recorded in a disk, on the basis of such information, by a method conforming with the data. And in a reproduction mode, the data are reproduced, on the basis of such information, by a method conforming with the data.

Modern computers utilize data buses to move data from one area of the computer to another. A modern computer has multiple data buses that interconnect different components of the computer system. Computer buses typically are implemented by a series of copper lines within a printed circuit board generally referred to as “traces.” A computer data bus is essentially a shared highway that interconnects different components of a computer system, including a microprocessor, disk-drive controller, memory, and input/output ports. Buses are characterized by the number of bits of data that they are able to transfer at a single time (e.g., an 8-bit data bus simultaneously transfers 8 bits of data in parallel; a 16-bit data bus simultaneously transfers 16 bits in parallel). The bus is integral to internal data transfer. Modern personal computers have specialized data buses to maximize operational efficiency. High performance data buses within modern personal computers are specialized for interconnecting transaction intensive sub-systems. Generally, buses coupled directly to the main processor transfer data at a higher rate than peripheral buses. High-speed buses require special design considerations to ensure system integrity.

Industry standards for bus architectures have been created by organizations within the computer industry. One such architecture that is gaining popularity is an architecture containing a “PCI bus.” The PCI bus specification was derived from provisions introduced by Intel Corporation. The Intel provisions detail a local bus system for a personal computer. A PCI-compliant circuit cards can operate in a computer built to PCI standards. The PCI specification is continually being reviewed by computer industry committees such as the “PCI Special Interest Group.” An operational PCI local bus requires a PCI controller card to regulate bus utilization. Typically, the PCI controller card is installed in one of the PCI card receiving sockets. The PCI controller can exchange data with the computer's central processor, simultaneously ransferring either 32 bits or 64 bits of data, depending on the implementation. A PCI controller additionally allows intelligent PCI-compliant adaptors to perform tasks concurrently with the CPU utilizing a technique called “bus mastering.” The PCI specification also allows for multiplexing. Microsoft Press Computer Dictionary 295 (2ed. 1994). Another bus standard is an industry standard bus. A PCI bus is a higher level or faster bus than the Industry Standard (ISA) bus. An ISA bus is typically utilized to interconnect a keyboard to the computer system, whereas a PCI bus typically interconnects devices requiring faster communication, such as disk drives and communication interfaces. Due to the high data rate on a PCI bus, the physical interconnection of PCI-compliant circuit boards is critical. Transmission line properties such as interference susceptibility, impedance and length are critical to ensure bus communication integrity.

Computers built to PCI specifications can be upgraded or enhanced by adding PCI-compliant circuit cards. A PCI-compliant circuit board is often referred to as a “PCI card” by those skilled in the art. Printed circuit boards that are sold to consumers generally have been subjected to extensive development and testing prior to their sale. The development phase of a printed circuit board can be very expensive. Design and production defects that avoid detection due to inadequate test capabilities can substantially add to the cost of a product. Production delays due to insufficient testing resources further add to the cost of a product. A conventional personal computer contains a “motherboard” which provides internal buses to interconnect a main processor with other sub-systems of the computer. The motherboard is the main circuit board containing the primary components of the computer system. A PCI circuit board undergoing a thorough development procedure must be electrically connected to an operational computer system. Due to the compactness of motherboards and rigid PCI bus specifications, PCI connectors are typically located close together on a motherboard. Visual access, as well as physical access to electrical signals during operation of PCI compatible circuit boards may be extremely limited. Access to desired locations on a PCI circuit card during a test that utilizes a motherboard requires that the PCI card be remotely located from the motherboard. Testing typically requires an extension cable or an adaptor cable. For example, extension cables can be plugged into the motherboard and the PCI card, then the PCI card can be placed in a location which provides full access.

Alternately, special devices such as extender circuit boards can be plugged into a PCI card receiving socket to extend a duplicative connector at a location above surrounding PCI cards. An extender card places the board under test above surrounding obstructions and allow access to signals on the PCI card. Often, initial PCI card design concepts are hand-wired by technicians. Typically, hand wired prototype circuit boards are physically much larger than allowed by the PCI specification. Hence, many conceptual designs will not fit in a conventional motherboard environment due to space constraints. A commonly utilized development tool is a PCI extender card having right angle connectors. Extender cards with right angles provide access to signals on the top side of the PCI compatible circuit board, however, access to signals on the underside of the PCI card is again limited. Further, only one right angle extender card per system can be attached to the motherboard.

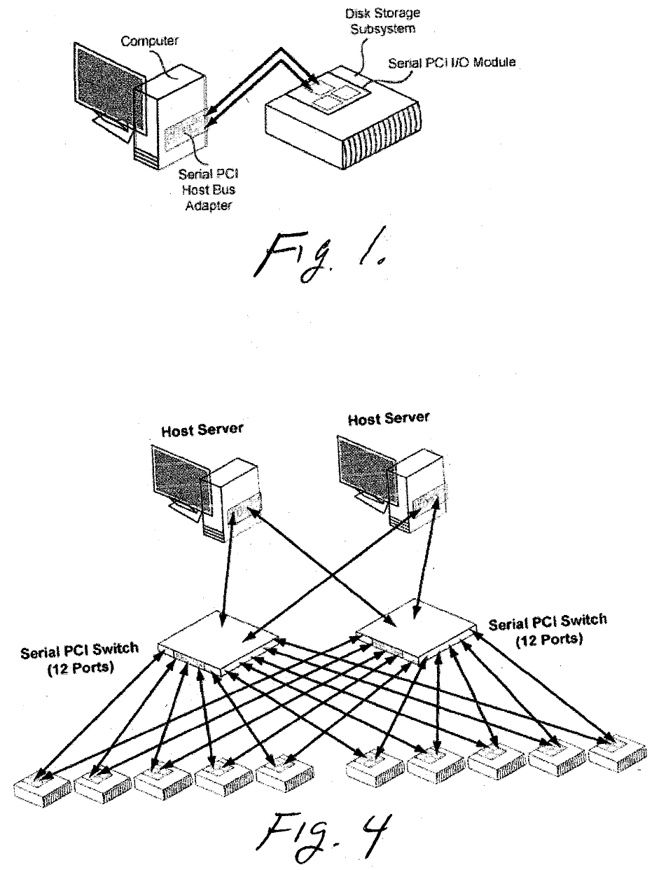

Generally, each party to the development of a PCI card has different requirements. Hence, a large quantity of application specific extender cards or test fixtures are built during the development of a product. Often, an application specific test fixture is useless after completion of the development of a specific PCI card. Extender cards and test fixtures add to the cost of product development. Additionally, the added transmission line lengths introduced by adaptor cables and/or extender cards can create phenomena which is not present when the PCI card is plugged directly into a motherboard. More particularly, card extenders or adaptors may degrade the signal quality on the PCI bus. Cables having excessive lengths induce data transfer problems, particularly timing skew and interference. Currently, in the development of PCI compatible circuit boards, the circuit boards must operate in an electrical environment that is different from the electrical environment found in actual field operation. Often, not all of the design problems and difficulties can be determined utilizing extender cards and/or adaptor cables. Additionally, problems manifest in the development of PCI circuit cards that are a result of the test environment. It therefore should be obvious that there is a need for a system and method for allowing access to the surface of a PCI compatible circuit board during operational testing. Further, a need exists for a reusable test fixture that accommodates oversized PCI compatible circuit boards. Additionally, it has become apparent that adequate testing of a PCI compatible card requires a test environment that accurately simulates field operating conditions. FIG. 1 depicts an architecture commonly utilized in a modern personal computer. A subset of the depicted computer elements or a state-of-the-art, sophisticated computer system could utilize the present invention. FIG. 1 should not be construed in a limiting sense as it is only one representative model of a system that could be utilized in cooperation with the present invention. The present invention relates to an arrangement for mounting Serial ATA data devices in a peripheral component and more particularly to a modular data device assembly adapted to mount in an industry standard size slot.

U.S. Pat. No. 6,446,148 teaches a protocol for expanding control elements of an ATA-based disk channel that supports device command and data information issued over the channel to a number of peripheral devices coupled to the channel. In addition, channel command circuitry issues channel commands which control channel related functional blocks, each of which perform non device-specific channel related functions. The channel commands are interpreted by the channel and are not directed to peripheral devices coupled thereto. Channel commands include identification indicia that distinguish a channel command from a device command.

U.S. patent application Ser. No. 20,020,087,898 teaches an apparatus that facilitates direct access to a serial Advanced Technology Attachment (ATA) device by an autonomous subsystem in the absence of the main operating system.

Since 1982 magnetic disk drive devices that are used as storage devices and expansion arrays of those storage devices haves progressed almost exponentially over time, and continue to do so. The attachment of additional disk drives above and beyond those contained in the host computer or server has used primarily the SCSI (Small Computer System Interface) or FC-AL (Fibre Channel Arbitrated Loop) bus, and compatible disk controllers and disk drive devices to achieve array expansion.

The inventor hereby incorporates the above referenced patents into this specification.

### SUMMARY OF THE INVENTION

The invention is a peripheral data storage subsystem for use with a computer system that has a host PCI bus and a serial PCI link interconnect.

In a first aspect of the invention the computer system includes a serial PCI host bus adapter coupled to the host PCI bus.

In a second aspect of the invention the peripheral data storage subsystem includes four serial ATA storage devices, a serial ATA to parallel PCI bridge that is coupled to each of the four serial ATA storage devices and a parallel PCI to serial PCI bridge that is coupled to the serial ATA to parallel PCI bridge. The serial PCI link interconnect couples the parallel PCI to serial PCI bridge of the peripheral data storage subsystem to the serial PCI host bus adapter of the computer system.

### DESCRIPTION OF THE PREFERRED EMBODIMENT

Referring to FIG. 1 a typical configuration of a computer includes a host bus adapter, interconnects; and a disk storage subsystem. Other common approaches c. 2002 include using Universal Serial Bus, and Firewire (IEEE 1394) bus attaching to ATA (AT Attachment, also commonly called ATAPI for AT Attachment Packet Interface) disk drive devices using device-mounted adapters, and creating RAID (Redundant Array of Independent Disks) arrays using ATA devices and array-located controllers which adapt ATA drives to common storage bus expansion architecture, including SCSI and FC-AL. The limitations and disadvantages of traditional approaches listed above include the size of the arrays that can be assembled; the data transfer speeds that can be achieved; interconnect cable length limits; and the high cost of interface connectors, adapters, converters and cables due to their specialized nature.

This application details a new approach to mass storage device array expansion, and uses S-ATA (Serial-ATA) devices and PCI (Peripheral Component Interconnect) bus to accomplish such expansion in a low-cost, high-performance and greatly scalable manner. (Note: Besides the PCI bus used in these examples, PCIx or other extendable interconnect buses, e.g., VME [VERSA Module Eurocard], VME64 [64-bit VME], VXI [VME eXtensions for Instrumentation], cPCI [Compact PCI], and Futurebus+ may be used and are assumed to be covered by this discussion.)

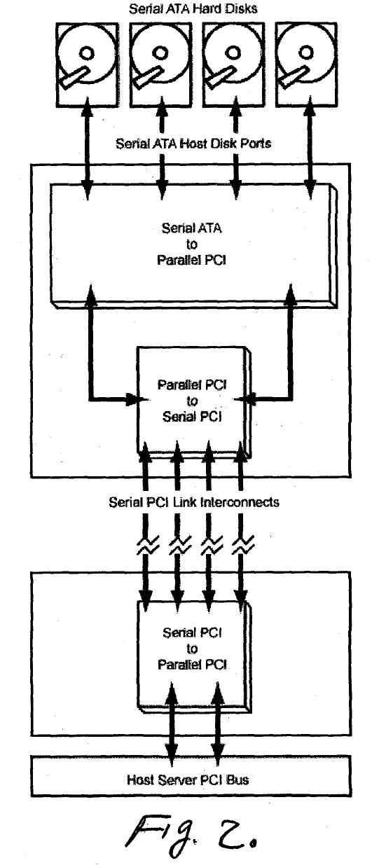

Referring to FIG. 2 using new-generation (c. 2002) ASIC (Application-Specific Integrated Circuit) devices which bridge (electronically adapt) the S-ATA bus to 64-bit PCI (etc. as stipulated in the preceding) bus, arrays of storage devices can be assembled such that 256 PCI targets, each of which may contain a plurality of disks, to form very large scale storage systems providing higher speed data transfers at lower cost than previously possible. Using c.2002 production disk densities and available devices, such an array (example: 256 targets, 16 drives per target) can have a capacity of 720 PB (Petabytes), or 754, 974, 720 GB (Gigabytes)*. This is record-breaking capacity vs. throughput already, but an added benefit to this approach is cost. S-ATA devices, per industry leaders including the disk mechanism manufacturers, will cost approximately 30% what SCSI and FC-AL devices of similar capacity cost, on the open market. Although not scalable on their own, S-ATA devices bridged to PCI bus architecture are enormously scalable as discussed in the preceding. A small-scale disk storage subsystem includes a computer, a PCI host adapter with serial PCI links, link interconnects, serial PCI link to PCI bridge chips and PCI to S-ATA bridge chips which fan out to S-ATA drives.

In order to achieve the inexpensive and fast throughput interconnections of host computers to disk arrays, the new approach discussed uses ASICs which form the bridge from S-PCI (serial PCI, a new bus which uses serialized PCI architecture and overcomes the former [parallel] PCI bus expansion obstacles) to PCI and allows the use of inexpensive copper wire twisted pair cabling, similar to CAT5 (Category 5 networking) cable and connectors to provide full-bandwidth PCI performance over inexpensive serial wiring. This in itself is new technology likely covered in other applications; this application is not for S-PCI bridge ASICs, but for the implementation thereof, along with other bridge devices and a Rabinovitz-Danino-developed PCI to S-PCI host bus adapter, to form large scale disk storage arrays which provide very fast I-O (input-output) transfers over reasonably long lengths of inexpensive cables, using S-ATA storage devices. The estimated data transfer speed of 528 MB/s (Megabytes per second), which is faster than current SCSI or FC-AL (or ATA) technology c.2002, is achievable with this approach.

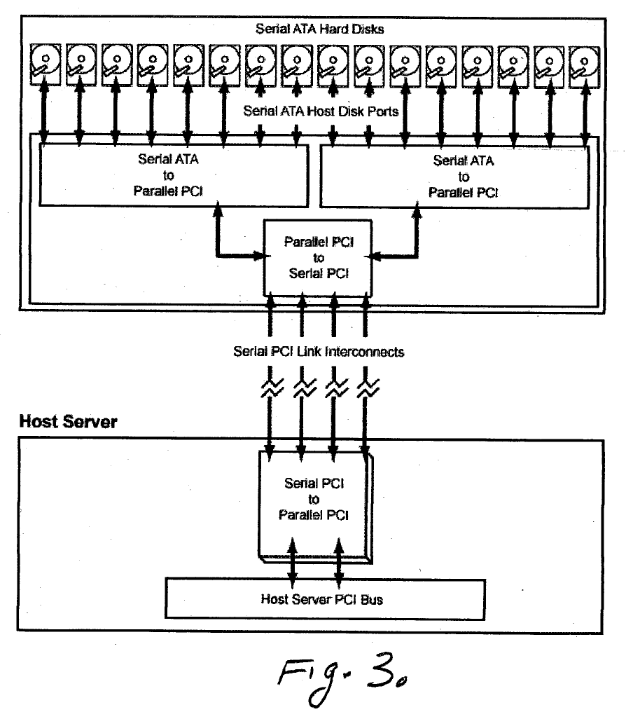

Referring to FIG. 3 an entire large scale storage subsystem using the implementations discussed above includes a computer with standard frontside PCI bus, e.g., 64-bit, 66 MHz, a JMR PCI host adapter with S-PCI link I-O ports, a CAT5 interconnecting cables, a disk storage array subsystem enclosure containing S-PCI link I-Os to PCI bridge ASIC and also containing two PCI to S-ATA ASICs providing connectivity to eight (8) S-ATA disk devices each, thus providing up to as many as sixteen (16) S-ATA disk drives in a JBOD (Just a Bunch Of Disks) configuration for disk torage expansion of the host computer. Note that this block diagram depicts a configuration that can serve any quantity of external disk storage devices from one (1) to infinity, and the product to be sold might contain any such number of devices. The block diagram is only an example of the type of storage subsystem that may be assembled using the approach discussed herein.

Referring to FIG. 3 in conjunction with FIG. 4 a minimum configuration has potential single points of failure, such as the host itself. To demonstrate how scalable this approach is a fault-tolerant, large scale, expandable disk array system's elements might include two identical servers, each containing a PCI-to-S-PCI HBA (host bus adapter) with dual link I-Os, two S-PCI switches, each having twelve (12) link I-O ports, ten 15-disk S-ATA enclosures, each having S-PCI link I-Os for host connectivity and internal ASIC bridges from S-PCI to PCI, and PCI to S-ATA. This system configuration provides exceptional fault-tolerance, typical of a “cluster” configuration as described in Microsoft Windows□ NT, with no single point of failure, and redundancy in all system elements. Some of that redundancy is provided by the standard Fortra design, which employs redundant (N+1) power, cooling and interconnectivity. Additional fault-tolerance, provided by redundancy, comes from the dual host and dual switch cluster configuration. It must be stressed that this application is intended to cover S-ATA to extendable-bus interconnections], serially connected to a the PCI host bus adapter[s] and may involve S-PCI or any number of extendable bus adapters, any quantity of targets, and any quantity of storage devices. The block diagrams depict typical configurations that may be assembled using commonly-available c.2002 storage blocks, the disk array enclosures. The S-PCI Switches shown in FIG. 4 are built directly into the disk array enclosures, in most cases, thus, they are shown as separate diagramatic blocks for clarification only. Building the S-PCI Switch into the disk array enclosure is a cost-saving and space-saving measure, to reduce the cost and space consumed by a separate switch enclosure, and the extra I-O link cables that would be required if a separate switch enclosure were used. Technically, if all switches were twelve (12) port devices as indicated, only every fourth Fortra would require an internal S-PCI switch, because one switch can serve two server I-O links and four disk storage I-O links (six links=12 ports). By installing a switch in only every fourth Fortra, there is a substantial cost-savings for the user, with no sacrifice in data integrity or fault-tolerance.

Still referring to FIG. 4 the system depicted includes ten products containing fifteen (15) 180 GB (typ) capacity S-ATA disk drives each, would have a total mass storage capacity of 27 TB (27,000 GB) while occupying only 30 rack units (30 RU) of vertical equipment cabinet space for the storage elements, including switches. This is currenly unheard-of capacity (c.2002) for an inexpensive disk array.

Referring to FIG. 4 in conjunction with FIG. 5 The systems that is diagrammed thus far are JBOD disk arrays, however, in all cases, they could be RAID arrays to provide fault-tolerance or special performance enhancements. RAID would be implemented in the Serial PCI bus, using an embedded systems approach (firmware), and includes all RAID options, e.g., RAID 0, 1, 5, 10 and 50. In this case, each disk array product, for example the 15-bay storage subsystem enclosures would be its own RAID.

Further, because the PCI bus is being extended to each disk array chassis, enclosure or shelf, and the conversion of S-PCI (or other bus as noted previously) to PCI occurs within said chassis, enclosure or shelf, a standard PCI slot, or two, or more, could be included in that array enclosure, thus providing for PCI connected peripherals remotely from the host computer, co-located with the disk array itself. This essentially allows general user interface computer functionality at “both ends” of the system; a monitor, speaker, network adapter or other peripheral could be attached directly to the disk enclosure via the appropriate PCI card.

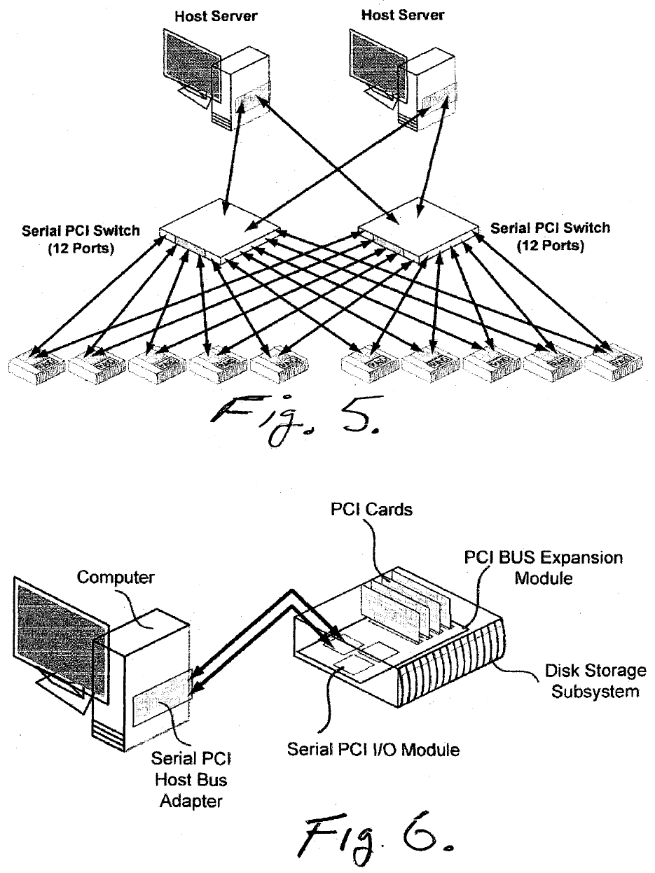

Referring to FIG. 6 peripherals may be connected to the disk expansion chassis via standard PCI interface.

What is claimed is:

1. A peripheral data storage subsystem for use with a computer system having a PCI bus and a parallel PCI to serial PCI, said peripheral data storage subsystem comprising:
a. a plurality of data storage devices;
b. a data storage device to serial PCI link coupled to each of said data storage devices;
c. a serial PCI link wherein said serial PCI link couples said parallel PCI to serial PCI bridge of said peripheral data storage subsystem to said serial PCI host bus adapter of said computer system.

2. A combined computer system and peripheral data storage subsystem comprising:
d. a computer system which includes:
i. a host PCI bus; and
ii. a serial PCI host bus adapter coupled to said host PCI bus;
e. a peripheral data storage subsystem which includes:
four serial ATA storage devices;
i. a serial ATA to parallel PCI bridge coupled to each of said four serial ATA storage devices; and
ii. a parallel PCI to serial PCI bridge coupled to said serial ATA to parallel PCI bridge; and
f. a serial PCI link interconnect wherein said serial PCI link interconnect couples said parallel PCI to serial PCI bridge of said peripheral data storage subsystem to said serial PCI host bus adapter of said computer system.

3. A combined computer system and peripheral data storage subsystem comprising:
a. a computer system which includes:
i. a host PCI bus; and
ii. a parallel PCI to serial PCI bridge coupled to said host PCI bus;
b. a peripheral data storage subsystem which includes:
i. an enclosure having a back-plane with slots for fifteen serial ATA storage devices;
ii. fifteen serial ATA data storage devices each of which is inserted into one of said fifteen slots of said back-plane;
iii. a first serial ATA to parallel PCI bridge disposed in said enclosure and coupled to each of eight of said fifteen serial ATA storage devices;
iv. a second serial ATA to parallel PCI bridge disposed in said enclosure and coupled to each of the remaining seven of said fifteen serial ATA storage devices; and
v. a parallel PCI to serial PCI bridge coupled to said first and second serial ATA to PCI parallel bridges; and
c. a serial PCI link interconnect wherein said serial PCI link interconnect couples said parallel PCI to serial PCI bridge of said peripheral data storage subsystem to said serial PCI host bus adapter of said computer system.

4. a combined computer system and peripheral data storage subsystem comprising:
a. a computer system which includes:
i. a host PCI bus; and
ii. a serial PCI host bus adapter coupled to said host PCI bus;
b. ten peripheral data storage subsystems each of which includes:
i. an enclosure having a back-plane with slots for fifteen serial ATA storage devices;
ii. fifteen serial ATA data storage devices each of which is inserted into one of said fifteen slots;
iii. a first serial ATA to parallel PCI bridge disposed in said enclosure and coupled to each of eight of said fifteen serial ATA storage devices;
iv. a second serial ATA to parallel PCI bridge disposed in said enclosure and coupled to each of the remaining seven of said fifteen serial ATA storage devices; and
v. a parallel PCI to serial PCI bridge coupled to said first and second serial ATA to PCI parallel bridges;
vi. a serial PCI switch wherein said first serial PCI switch couples said parallel PCI to serial PCI bridge of each of said fifteen peripheral data storage subsystems to said serial PCI host bus adapter of said computer system.

5. A combined computer system and peripheral data storage subsystem according to claim 3 wherein each of said ten peripheral data storage subsystem has a RAID controller.

6. A combined computer system and peripheral data storage subsystem comprising:
c. two computer systems each of which includes:
i. a host PCI bus; and
ii. a serial PCI host bus adapter coupled to said host PCI bus;
d. ten peripheral data storage subsystems each of which includes:
ii. an enclosure having a back-plane with slots for fifteen serial ATA storage devices;
vii. fifteen serial ATA data storage devices each of which is inserted into one of said fifteen slots;
viii. a first serial ATA to parallel PCI bridge disposed in said enclosure and coupled to each of eight of said fifteen serial ATA storage devices;
ix. a second serial ATA to parallel PCI bridge disposed in said enclosure and coupled to each of the remaining seven of said fifteen serial ATA storage devices; and
x. a parallel PCI to serial PCI bridge coupled to said first and second serial ATA to PCI parallel bridges;
xi. a first serial PCI switch wherein said first serial PCI switch couples said parallel PCI to serial PCI bridge of each of said fifteen peripheral data storage subsystems to said serial PCI host bus adapter of each of said two computer systems; and
xii. a second serial PCI switch wherein said second first serial PCI switch couples said parallel PCI to serial PCI bridge of each of said fifteen peripheral data storage subsystems to said serial PCI host bus adapter of each of said two computer systems.

7. A combined computer system and peripheral data storage subsystem according to claim 5 wherein each of said ten peripheral data storage subsystem has a RAID controller.
